(19) United States
(12) Patent Application Publication
(10) Pub. No.: US 2019/0018422 A1
(43) Pub. Date: Jan. 17, 2019

(54) ROBOT RECHARGE CONTROL METHOD, ROBOT AND ROBOT SYSTEM

(71) Applicant: UBTECH Robotics Corp, Shenzhen (CN)

(72) Inventors: Youjun Xiong, Shenzhen (CN); Gaobo Huang, Shenzhen (CN); Caixia Li, Shenzhen (CN); Xiangbin Huang, Shenzhen (CN)

(21) Appl. No.: 16/035,569

(22) Filed: Jul. 13, 2018

(30) Foreign Application Priority Data
Jul. 14, 2017 (CN) 201710577025.1

(51) Int. Cl. G05D 1/02

(52) U.S. Cl. CPC G05D 1/0225; G05D 1/0276; G05D 1/0242

(57) ABSTRACT

The present disclosure discloses a robot recharge control method, a robot and a robot system. The robot recharge control method includes: moving a robot to a first position of one of two edge lines of a preset detection signal region; moving the robot from the first position to a second position of the other edge line of the preset detection signal region; moving the robot from the second position to a midpoint of a line connecting the first position and the second position; and moving the robot from the midpoint to the dock section of the charging base. By detecting the two edge lines of the preset detection signal region, the first position and the second position which are axisymmetric with respect to the dock section are found, and then a center point corresponding to the dock section is found through the first position and the second position.

### CROSS REFERENCE TO RELATED APPLICATIONS

This application claims priority to Chinese Patent Application No. 201710577025.1, filed Jul. 14, 2017, which is hereby incorporated by reference herein as if set forth in its entirety.

### BACKGROUND

### 1. Technical Field

The present disclosure relates to intelligent robot technology, and particularly to a robot recharge control method, a robot and a robot system.

### 2. Description of Related Art

With the rapid development of technology, intelligent robots have gradually become a hotspot of research, and are being favored by the market. In particular, service robots are increasingly welcomed by users and have huge market potential. As the user demands continue to increase, robots are becoming more and more intelligent.

Currently, robots (e.g., sweeping robots and large wheeled robots) generally have the automatic charging function. In the prior art, most robots are recharged by infrared calibration methods so as to perform automatic recharging, and determine the position of the charging base by searching for a center infrared beam in a rough manner, and then directly docks. The success rate of docking through this type of recharge control method is about 80%, which has a relatively large failure rate, and the robot may collide with the charging base when the robot is not successfully docked. For the sweeping robots, because they generally have a light touch housing, the equipment can be prevented from being damaged due to the collision during the docking process. Therefore, even if the docking is unsuccessful when recharging, it will not have much impact. However, for the large wheeled robots, because they have not a light touch housing, the equipment may be damaged by the collision of the robot and the charging base due to the deviation of docking during the docking process.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of an embodiment of a robot recharge control method according to the present disclosure.

FIG. 2A is a schematic diagram of a structure for the embodiment of the robot recharge control method according to the present disclosure.

FIG. 2B is a schematic diagram of a structure for another embodiment of the robot recharge control method according to the present disclosure.

FIG. 3 is a flow chart of step S10 of another embodiment of a robot recharge control method according to the present disclosure.

FIG. 4 is a flow chart of step S103 in FIG. 3.

FIG. 5 is a flow chart of step S20 of still another embodiment of a robot recharge control method according to the present disclosure.

FIG. 6 is a flow chart of step S30 of the other embodiment of a robot recharge control method according to the present disclosure.

FIG. 7 is a flow chart of step S40 of to the other embodiment of the robot recharge control method according the present disclosure.

FIG. 8 is a schematic diagram of the structure of an embodiment of an automatic recharging robot according to the present disclosure.

FIG. 9 is a schematic diagram of the structure of an embodiment of an automatic recharging robot system according to the present disclosure.

FIG. 10 is a schematic diagram of an embodiment of a storage device according to the present disclosure.

### DETAILED DESCRIPTION

In order to make those skilled in the art better understand the solutions of the present disclosure, a robot recharge control method, a robot and a robot system of the present disclosure will be described clearly below with reference to the accompanying drawings in the embodiments of the present disclosure. Apparently, the described embodiments are merely part of the embodiments of the present disclosure, but not all of the embodiments. All other embodiments obtained by those skilled in the art based on the embodiments of the present disclosure without creative efforts shall fall within the protection scope of the present disclosure.

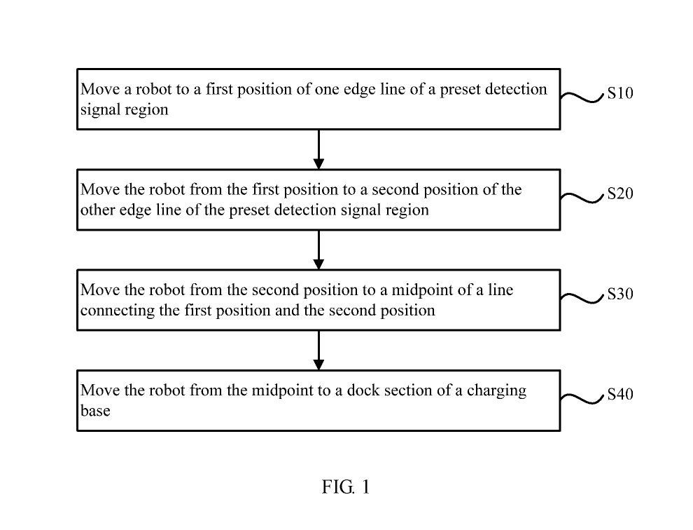

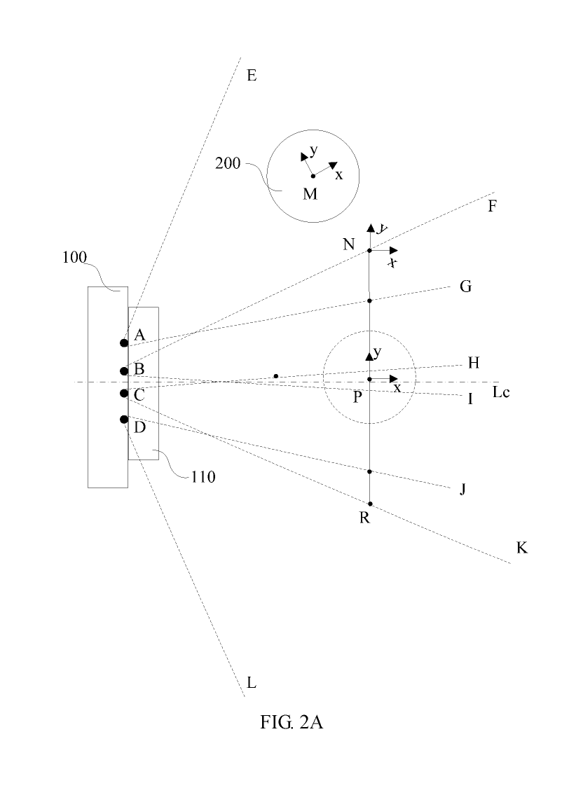

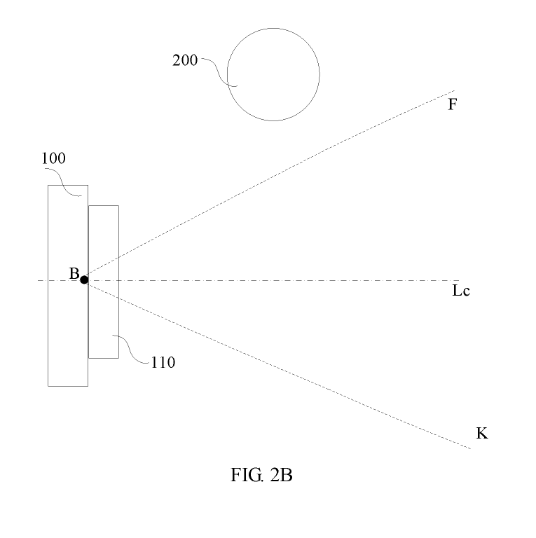

FIG. 1 is a flow chart of an embodiment of a robot recharge control method according to the present disclosure. FIG. 2A is a schematic diagram of a structure for the embodiment of the robot recharge control method according to the present disclosure. A charging base 100 is for a robot 200 to charge, and the charging base 100 includes a dock section 110 for the robot 200 to dock. The size of the dock section 110 may be changed according to the size of the robot 200. In this embodiment, the method is a computer-implemented method executable for a processor. The method can be applied to a robot, where the robot can be equipped with sensors, such as infrared sensors, ultrasound sensors, or laser sensors. As shown in FIG. 1 and FIG. 2A, the method includes the following steps.

S10: moving a robot to a first position of one of two edge lines of a preset detection signal region.

In this embodiment, signal emitter(s) are disposed on the charging base 100 of the robot 200, and emit a detection signal at a certain emission angle to form a plurality of detection signal regions. An area between two edge lines which are substantially axisymmetric with a central line Lc of the dock section 110 of the charging base 100 is assumed as the preset detection signal region, and the dock section 110 of the charging base 100 is located between the signal emitters. In this embodiment, the robot is moved from a current position where the robot is locate to one edge line of the preset detection signal region, and the position of the robot on the edge line is the first position.

As shown in FIG. 2A, tour signal emitters A, B, C, and D are provided on the charging base 100 of the robot 200, and the central line Lc of the dock section 110 of the charging base 100 is located between the signal emitters B and C. Each of the signal emitters emits detection signals confined by two edge lines of a certain angle. That is, the detection signals from the signal emitter A forms a first detection signal region bounded by edge lines AE and BF, a second detection signal region bounded by edge lines BF and CK, and a third detection signal region bounded by edge lines CK and DL. Edge lines BF and CK are set to be axisymmetric with respect to the central line Lc of the dock section 110 of the charging base 100. The second and third detection signal regions defined by edge lines BF and CK is taken as the preset detection signal region. Assuming that the position where the robot 200 is currently located is M, the robot 200 is moved from the point M to the point N on the edge line BF of the preset detection signal region. The point N is considered to be the first position N.

It can be understood that, in other embodiments, the number of the signal emitters provided on the charging base 100 of the robot 200 can be changed according to actual needs. In this embodiment, the number of the signal emitters is at least 3, the angle of the signal emitters to emit the detection signal may also be adjusted accordingly, and the preset detection signal region may also be composed of other detection signals. For example, the detection signal region between AG and DJ may also be taken as the preset detection signal region, as long as AG and DJ are axisymmetric with respect to the central line Lc of the dock section 110 of the charging base 100. FIG. 2B is a schematic diagram of a structure for another embodiment of the robot recharge control method according to the present disclosure. As shown in FIG. 2B, the number of the signal emitter may be 1 (the signal emitter B). In other embodiments, the number of the signal emitters may be 2 or more than 2.

Furthermore, in this embodiment, the signal emitters may be infrared signal emitters, and the corresponding detection signals are infrared detection signals.

S20: moving the robot from the first position to a second position of the other edge line of the preset detection signal region.

The move track of the robot 200 keeps substantially parallel to a lateral extension direction of the dock section 110 (i.e., the direction perpendicular to the central line Lc of the dock section 110). Specifically, as shown in FIG. 2A, after the robot 200 reaches the first position N, a moving direction of the robot 200 to the other edge line CK of the preset detection signal region is adjusted, such that the move track is substantially parallel to the lateral extension direction of the dock section 110.

The robot 200 is moved in the adjusted moving direction until the robot 200 reaches the other edge line CK of the preset detection signal region. The position where the robot 200 reaches the edge line CK is the second position R.

It can be understood that, because the two edge lines BF and CK of the preset detection signal region are axisymmetric with respect to the central line Lc of the dock section 110 of the charging base 100, and the moving direction from the first position N to the second position R is parallel to the lateral extension direction of the dock section 110, the first position N and the second position R are also axisymmetric with respect to the central line Lc of the dock section 110 of the charging base 100.

In other embodiment, the move track of the robot 200 can slightly deviate from the parallel direction. In order to make the first position N and the second position R as axisymmetric as possible with respect to the central line Lc of the dock section 110 of the charging base 100, the deviation angle should not be too large, otherwise the first position N and the second position R will have a large deviation and eventually cause the robot 200 being unable to dock at the charging base 100 in a relatively accurate manner. Optionally, the deviation angle is less than or equal to 15 degrees, for example, the deviation angle may be 3 degrees, 5 degrees, 8 degrees, 10 degrees, or 12 degrees.

S30: moving the robot from the second position to a midpoint of a line connecting the first position and the second position.

As shown in FIG. 2A, since the first position N and the second position R are axisymmetric with respect to the central line Lc of the dock section 110 of the charging base 100, the midpoint P of the line NR aligns with the center of the dock section 110 of the charging base 100.

Therefore, after the robot 200 moves back from the second position R to the midpoint P, the robot 200 aligns with the center of the dock section 110 of the charging base 100.

S40: moving the robot from the midpoint to the dock section 110 of the charging base.

As can be seen from FIG. 2A, when the robot 200 is at the midpoint P, the robot 200 can align the dock section 110 of the charging base 100 in a relatively accurate manner. At this time, it merely needs to move the robot 200 to the dock section 110 of the charging base 100.

It can be understood that, if the move track of the robot 200 is exactly parallel to the charging base 100 in step S20, the robot 200 at the midpoint P is right facing the dock section 110 of the charging base 100; if there is a deviation angle between the move track of the robot 200 and the charging base 100 in step S20, the robot 200 moves back to the midpoint P in a relatively less accurate manner, and there will be a certain error therebetween, but the error has less influence on the robot 200 to eventually move to the dock section 110 as long as the deviation angle is less than or equal to a preset angle which is chosen depending on the distance of line NR.

In this embodiment, through detecting the two edge lines of the preset detection signal region which are axisymmetric with respect to the central line Lc of the dock section 110 of the charging base 100, the robot 200 finds the first position N and the second position R which are axisymmetric with respect to the central line Lc of the dock section 110 of the charging base 100 on the two edge lines respectively, further determines the position of the midpoint P corresponding to the dock section 110 of the charging base 100, and is finally moved from the midpoint P to the dock section 110 of the charging base 100. Through the searching for a series of related positions, the dock section 110 of the charging base 100 is finally found in a relatively accurate manner, thereby increasing the success rate for docking the robot 200, and at the same time, the damage of the equipment caused by the collision of the robot 200 with the charging base 100 during the movement is avoided.

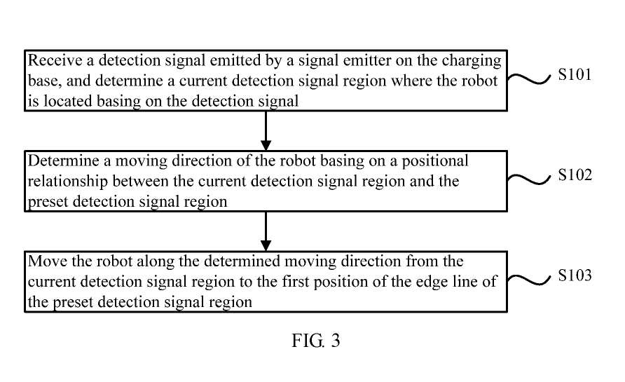

Furthermore, FIG. 3 is a flow chart of step S10 of another embodiment of a robot recharge control method according to the present disclosure. As shown in FIG. 3, step S10 includes the following steps.

S101: receiving a detection signal emitted by the signal emitter on the charging base, and determining a current detection signal region where the robot is located basing on the detection signal.

In this embodiment, it is necessary to determine the position where the robot 200 is currently located and the relationship between the position and the preset detection signal region while the robot 200 reaches one edge line of the preset detection signal region, so as to determine the direction for the robot 200 to move to one edge line of the preset detection signal region.

In this embodiment, the carrier signals of the detection signals emitted by the signal emitters on the charging base 100 are different from each other. Therefore, the detection signals received by the robot 200 in different detection signal regions are all different. As shown in FIG. 2A, the detection signals received by the robot 200 in the first detection signal region are the detection signals emitted by the signal emitter A; the detection signals received in the second detection signal region includes the overlapped detection signals of the signal emitter A and the signal emitter B, the overlapped detection signals of the signal emitter B and the signal emitter C, the overlapped detection signals of the signal emitter C and the signal emitter D, and the detection signals of the signal emitter B and the signal emitter C. The detection signals received in the third detection signal region are the detection signal emitted by the signal emitter D.

The robot 200 can determine based on the received detection signal that whether the detection signal region where the robot 200 is current located is the first detection signal region, the second detection signal region, or the third detection signal region.

S102: determining the moving direction of the robot basing on a positional relationship between the current detection signal region and the preset detection signal region.

According to the detection signal region where the robot 200 is currently located which is determined in step S101, the positional relationship between the detection signal region and the preset detection signal region can be determined, and it can be determined basing on the positional relationship that the direction for the robot 200 to move to the first position N of one edge line of the detection signal region.

As shown in FIG. 2A, if the detection signal region where the robot 200 is currently located is the first detection signal region and the first detection signal region is located to the left of the preset detection signal region, the robot 200 needs to be moved to the right, that is, moved from the point M to the preset detection signal region; if the detection signal region where the robot 200 is currently located is the third detection signal region and the third detection signal region is located to the right of the preset detection signal region, the robot 200 needs to be moved to the left, that is, moved from a certain position in the third detection signal region to the preset detection signal region; if the robot 200 determines that the detection signal region where the robot 200 is currently located is the preset detection signal region, the robot 200 may determine that whether the edge line BF or the edge line CK of preset detection signal region is closer to the current position through the detected detection signal, and move the robot 200 to the closer edge line.

S103: moving the robot along the determined moving direction from the current detection signal region to the first position of the edge line of the preset detection signal region.

After the moving direction is determined in step S102, the robot 200 is moved from the current detection signal region to the first position N of one edge line of the preset detection signal region along the determined moving direction.

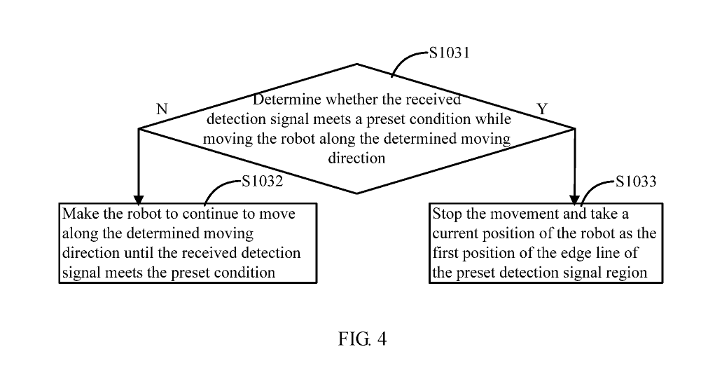

Furthermore, FIG. 4 is a flow chart of step S103 in FIG. 3. As shown in FIG. 4, step S103 may include the following steps.

S1031: determining whether the received detection signal meets a preset condition while moving the robot along the determined moving direction.

During the movement of the robot 200, the robot 200 receives the detection signal emitted by the signal emitter in real time or periodically, and determines whether the robot 200 has reached one edge line of the preset detection signal region by detecting the received detection signal.

As shown in FIG. 2A, the detection signals on two sides of the edge lines BF and CK of the preset detection signal region are different. One side of the edge line BF belongs to the first detection signal region, and its detection signal corresponds to the detection signal emitted by the signal emitter A; the other side belongs to the preset detection signal region, and its detection signal corresponds to the detection signals emitted by the signal emitters A and B. The detection signals of the edge line CK which belong to the third detection signal region correspond to the signal emitter D, and the detection signals of the edge line CK which belongs to the preset detection signal region correspond to the detection signals emitted by the signal emitters C and D.

In this embodiment, the preset condition is related to the positional relationship between the detection signal region where the robot 200 is currently located and the preset detection signal region.

If the detection signal region where the robot 200 is currently located is the first detection signal region or the third detection signal region, then the preset condition is that the detection signal detected by the robot 200 belongs to the preset detection signal region, that is, when the robot 200 is moved from the first detection signal region or the third detection signal region to the preset detection signal region, if the detection signal detected by the robot 200 becomes from not belonging to the preset detection signal region to belonging to the preset detection signal region, the received detection signal is determined to be meeting the preset condition.

If the detection signal region where the robot 200 is currently located is the preset detection signal region, the preset condition is that the detection signal detected by the robot 200 does not belong to the preset detection signal region, that is, when the robot 200 is moved from a position in the preset detection signal region to one edge line of the preset detection signal region, if the detection signal detected by the robot 200 becomes from belonging to the preset detection signal region to not belonging to the preset detection signal region, the received detection signal is determined to be meeting the preset condition. Step S1032 or step S1033 is selected to execute according to the detection result of step S1031.

S1032: making the robot to continue to move along the determined moving direction until the received detection signal meets the preset condition, in response to the received detection signal not meeting the preset condition.

If the received detection signal does not meet the preset condition, it means that the robot 200 has not reached the edge line of the preset detection signal region, and continues to be moved along the determined moving direction until the received detection signal meets the preset condition, and step S1033 is executed.

S1033: stopping the movement and taking a current position of the robot as the first position of the edge line of the preset detection signal region, in response to the received detection signal meeting the preset condition.

According to the above description of the preset condition, it can be understood that when the robot 200 determines that the received detection signal meets the preset condition, it indicates that the robot 200 has reached one edge line of the preset detection signal region, the robot 200 is stopped from moving at this time, and the position where the robot 200 is currently located is taken as the first position N of one edge line of the preset detection signal region.

It is worth noting that the robot 200 has a pre-set advance direction. The robot 200 is moved along the advance direction during the movement, and at this time, the moving direction of the robot 200 is the advance direction. In this embodiment, the robot 200 is provided with its own coordinate system, and the advance direction of the robot 200 is the direction of the y-axis in its own coordinate system. As shown in FIG. 2A, if the detection signal region where the robot 200 is currently located is the first detection signal region, and the coordinate system of the robot 200 is as shown in FIG. 2A. In this case, the advance direction of the robot 200 is the negative direction of the y-axis, that is, the robot 200 is moved along the negative direction of the y-axis of its own coordinate system until it reaches the edge line BF, and the position of the robot 200 on BF is the first position N.

In other embodiments, the advance direction of the robot 200 at this time may also be the direction of the x-axis. At this time, the robot 200 may need to be rotated according to actual situations to avoid that the direction of the x-axis and the edge line of the preset detection signal region are parallel or an (included) angle therebetween is too small, because the robot 200 may need to be moved for a longer distance to move to the edge line of the preset detection signal region if the direction of the x-axis and the edge line of the preset detection signal region are parallel or the angle therebetween is too small. As shown in FIG. 2A, the robot 200 can be rotated for a certain angle so that the direction of the x-axis points to the edge line BF.

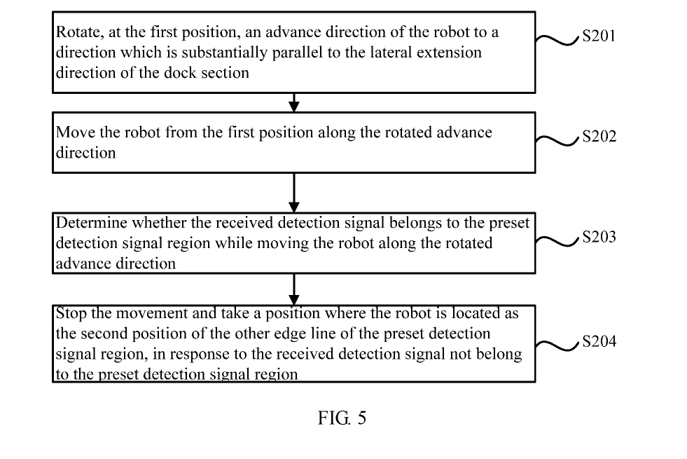

Furthermore, FIG. 5 is a flow chart of step S20 of still another embodiment of a robot recharge control method according to the present disclosure. As shown in FIG. 5, step S20 may include the following steps.

S201: rotating, at the first position, an advance direction of the robot to a direction which is parallel to the charging base or has an included angle with respect to the charging base that is less than or equal to the deviation angle.

As shown in FIG. 2A, in this embodiment, when the robot 200 reaches the first position N of one edge line of the preset detection signal region through step S10, the advance direction of the robot 200 is the direction of the y-axis of the robot 200. There is an included angle at a certain angle between the advance direction and one edge line of the preset detection signal region, and the direction of the y-axis does not necessarily meet the condition that being parallel to the charging base 100 or the deviation angle between the direction and the charging base 100 is less than or equal to the preset angle. The robot 200 is rotated so that the direction of the coordinate system of the robot 200 at the first position N on the edge line BF is as shown in the direction of the coordinate system at the point N in FIG. 2A. At this time, the advance direction of the robot 200, that is, the direction of the y-axis meets the condition that being parallel to the charging base 100 or the deviation angle between the direction and the charging base 100 is less than or equal to the preset angle. That is, the advance direction of the robot 200 is parallel to the charging base 100 or the included angle between the advance direction and the charging base 100 is less than or equal to the deviation angle.

S202: moving the robot from the first position along the rotated advance direction.

In this embodiment, since the advance direction of the robot is the direction of the y-axis, the robot 200 begins to be moved from the first position N along the rotated advance direction, that is, the negative direction of the y-axis, after the adjustment to the advance direction of the robot 200 through step S201.

S203: determining whether the received detection signal belongs to the preset detection signal region while moving the robot along the rotated advance direction.

During moving the robot 200 along the rotated advance direction, the robot 200 is moved within the preset detection signal region. Therefore, during the movement, the robot 200 needs to detect in real time that whether the received detection signal belongs to the preset detection signal region, thereby determining whether the robot 200 has reached the other edge line of the preset detection signal region.

S204: stopping the movement and taking a position where the robot is located as the second position of the other edge line of the preset detection signal region, in response to the received detection signal not belonging to the preset detection signal region.

If the detection signal received by the robot 200 no longer belongs to the preset detection signal region, it indicates that the robot 200 has moved from the first position N to the other edge line of the preset detection signal region. The position of the robot 200 on the other edge line of the preset detection signal region is taken as the second position R.

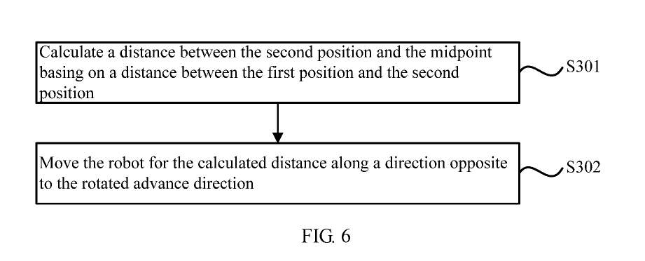

Furthermore, FIG. 6 is a flow chart of step S30 of the other embodiment of a robot recharge control method according to the present disclosure. As shown in FIG. 6, step S30 may include the following steps.

S301: calculating a distance between the second position and the midpoint basing on a distance between the first position and the second position.

In order to allow the robot 200 to move to the midpoint P between the first position N and the second position R, the position of the midpoint P of the first position N and the second position R are first determined. When the robot 200 is moved from the first position N to the second position R along the determined moving direction, the robot 200 can record a linear distance between the first position N and the second position R, and a distance from the second point R to the midpoint P can be calculated through the recorded linear distance.

S302, moving the robot for the calculated distance along a direction opposite to the rotated advance direction.

The robot 200 is moved along the adjusted advance direction, that is, the positive or negative direction of the y-axis of the robot 200 of this embodiment, while it is moved from the first position N to the second position R. At this time, the robot 200 may be moved back to the midpoint P of the line connecting the first position N and the second position R in the opposite direction of its advance direction (i.e., the negative or positive direction of the y-axis of the robot 200). The distance which the robot 200 is moved in this step is that the distance from the second point R to the midpoint P which is calculated in step S301. As shown in FIG. 2A, the robot 200 is moved from the edge line BF to the second position R on the edge line CK along the advance direction. At this time, the robot 200 is moved from the second position R to the middle point P of first position N and the second position R along the opposite direction of the advance direction.

In this embodiment, the advance direction of the robot 200 corresponds to the y axis of its coordinate system, and the installation position of a charging electrode of the robot 200 corresponds to the x axis of the coordinate system. As shown in FIG. 2A, since the y-axis of the robot 200 corresponds to the line connecting the first position N and the second position R, the positive or negative direction of the x-axis of the robot 200 corresponds to the dock section 110 of the charging base 100. That is, the charging electrode of the robot 200 just faces the dock section 110 of the charging base 100, or the charging electrode of the robot 200 is located at the back of a side just facing the dock section 110 of the charging base 100. In this embodiment, the charging electrode of the robot 200 is located in the positive direction of the x-axis of the coordinate system of the robot 200. At this time, the robot 200 may be moved to the dock section 110 of the charging base 100 along the x-axis. It can be understood that, in this embodiment, a part of the robot 200 which is docked to the dock section 110 of charging base 100 is provided on the negative direction of the x-axis. As shown in FIG. 2A, when the robot 200 reaches the midpoint P of the first position N and the second position R, it is necessary to determine the direction which the positive direction of the x-axis of the robot 200 is directed. If the positive direction of the x-axis of the robot 200 points to the dock section 110 of the charging base 100, the robot 200 needs to be rotated at an angle of approximately 180°, so that the negative direction of the x-axis of the robot 200 is directed to the dock section 110 of the charging base 100; otherwise, the robot 200 does not need to be rotated.

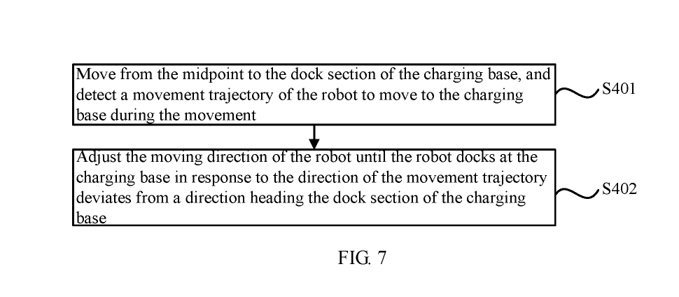

Furthermore, FIG. 7 is a flow chart of step S40 of to the other embodiment of the robot recharge control method according the present disclosure. As shown in FIG. 7, step S40 may include the following steps.

S401: moving from the midpoint to the dock section of the charging base, and detecting a movement trajectory of the robot to move to the charging base during the movement.

Since a mobile device of the robot 200 may be misaligned during the movement, the movement trajectory of the robot 200 may gradually deviate from the dock section 110 of the charging base 100 while the robot 200 is moved from the midpoint P to the dock section 110 of the charging base 100. Therefore, while the robot 200 is moved from the midpoint P to the dock section 110 of the charging base 100, the movement trajectory of the robot 200 can be detected so as to adjust the moving direction of the robot 200 in time.

S402: adjusting the moving direction of the robot until the robot docks at the charging base in response to the direction of the movement trajectory deviates from a direction heading the dock section of the charging base.

When it is detected in step S401 that the movement trajectory of the robot 200 is offset from the dock section 110 of the charging base 100, the moving direction of the robot 200 is adjusted in time so that the robot 200 can be moved along the direction corresponding to the dock section 110 of the charging base 100 as much as possible, until the robot 200 docks at the charging base 100.

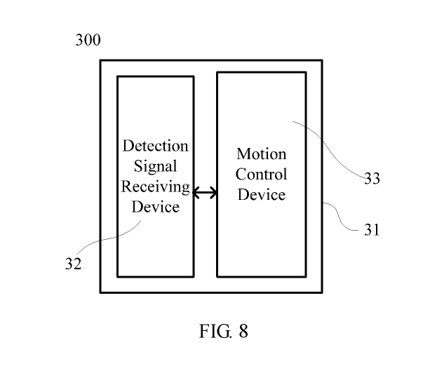

FIG. 8 is a schematic diagram of the structure of an embodiment of an automatic recharging robot according to the present disclosure. As shown in FIG. 8, in this embodiment, the robot includes a housing 31, a detection signal receiving device 32, and a motion control device 33. The detection signal receiving device 32 is disposed on the housing 31, the motion control device 33 is disposed inside the housing 31, and the detection signal receiving device 32 and the motion control device 33 are coupled to each other.

The detection signal receiving device 32 is configured to receive a detection signal emitted by a signal emitter on a charging base and transmit the detection signal to the motion control device 33. The motion control device 33 is configured to execute a computer program to execute the robot recharge control method in FIG. 1 to FIG. 6, which will not be described herein.

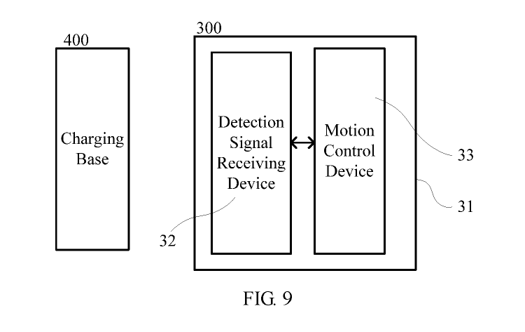

FIG. 9 is a schematic diagram of the structure of an embodiment of an automatic recharging robot system according to the present disclosure. As shown in FIG. 9, in this embodiment, the automatic recharging robot system includes a charging base 400 and the robot 300 shown in FIG. 8.

The charging base 400 is provided with at least 3 signal emitters, and detection signals emitted by the at least 3 signal emitters are different to each other. In which, the signal emitters may be infrared signal emitters. In other embodiments, the charging base 400 may be the charging base as shown in FIG. 2A, which will not be described herein.

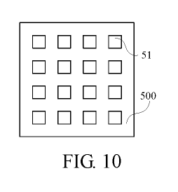

FIG. 10 is a schematic diagram of an embodiment of a storage device according to the present disclosure. As shown in FIG. 10, at least one program or instruction 51 is stored in the storage device 500. The program or the instruction 51 is configured to execute the robot recharge control method in FIG. 1 to FIG. 7, which will not be described herein. In one embodiment, the storage device 500 may be a storage chip or a hard disk in a terminal device, a removable hard disk, or other readable and writable storage tool such as a USB flash disk and an optical disk, and may also be a server or the like.

In this embodiment, through detecting the two edge lines of the preset detection signal region which are axisymmetric with respect to (a central line of) the dock section of the charging base, the robot finds the first position and the second position which are axisymmetric with respect to (the central line of) the dock section of the charging base on the two edge lines respectively, further determines the position of the midpoint P corresponding to the dock section of the charging base, and is finally moved from the midpoint P to the dock section of the charging base. Through the searching for a series of related positions, the dock section of the charging base is finally found in a relatively accurate manner, thereby increasing the success rate for docking the robot, and at the same time, the damage of the equipment caused by the collision of the robot with the charging base during the movement is avoided.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented recharge control method for a robot, comprising executing on a processor steps of:
moving the robot to a first position of one of two edge lines of a preset detection signal region, wherein the preset detection signal region includes a detection signal emission region of at least one signal emitter on a charging base, and the two edge lines of the preset detection signal region are substantially axisymmetric with respect to a central line of a dock section of the charging base;
moving the robot from the first position to a second position of the other edge line of the preset detection signal region, wherein a track of the movement is substantially parallel to a lateral extension direction of the dock section of the charging base;
moving the robot from the second position to a midpoint of a line connecting the first position and the second position; and
moving the robot from the midpoint to the dock section of the charging base.

2. The method of claim 1, wherein the step of moving the robot to the first position of the edge line of the preset detection signal region comprises:
receiving a detection signal emitted by a signal emitter on the charging base, and determining a current detection signal region the robot being located basing on the detection signal;
determining a moving direction of the robot basing on a positional relationship between the current detection signal region and the preset detection signal region; and
moving the robot along the determined moving direction from the current detection signal region to the first position of the edge line of the preset detection signal region.

3. The method of claim 2, wherein the step of moving the robot along the determined moving direction from the current detection signal region to the first position of the edge line of the preset detection signal region comprises:
determining whether the received detection signal meets a preset condition while moving the robot along the determined moving direction; and
stopping the movement and taking a current position of the robot as the first position of the edge line of the preset detection signal region, in response to the received detection signal meeting the preset condition.

4. The method of claim 1, wherein the step of moving the robot from the first position to the second position of the other edge line of the preset detection signal region comprises:
rotating, at the first position, an advance direction of the robot to a direction substantially parallel to the lateral extension direction of the dock section;
moving the robot from the first position along the rotated advance direction;
determining whether the received detection signal belongs to the preset detection signal region while moving the robot along the rotated advance direction; and
stopping the movement and taking a position the robot being located as the second position of the other edge line of the preset detection signal region, in response to the received detection signal not belong to the preset detection signal region.

5. The method of claim 4, wherein the step of moving the robot from the second position to the midpoint of the line connecting the first position and the second position comprises:
calculating a distance between the second position and the midpoint basing on a distance between the first position and the second position; and
moving the robot for the calculated distance along a direction opposite to the rotated advance direction.

6. The method of claim 1, wherein at least three signal emitters are provided on the charging base; and
the signal emitters are infrared signal emitters, the detection signals are infrared signals.

7. The method of claim 1, wherein the step of moving the robot from the midpoint to the dock section of the charging base comprises:
moving from the midpoint to the dock section of the charging base, and detecting a movement trajectory of the robot to move to the charging base during the movement;
adjusting the moving direction of the robot until the robot docks at the charging base in response to the direction of the movement trajectory deviating from a direction heading the dock section of the charging base; and
rotating the robot such that a charging electrode of the robot aligns with the dock section.

8. An automatic recharging robot comprising a housing, a detection signal receiving device, and a motion control device, wherein:
the detection signal receiving device is disposed on the housing, the motion control device is disposed inside the housing, the detection signal receiving device and the motion control device are coupled to each other,
the detection signal receiving device is configured to receive a detection signal emitted by a signal emitter on a charging base and transmit the detection signal to the motion control device; and
the motion control device comprises one or more processors, a memory, and one or more computer programs, wherein the one or more programs are stored in the memory and configured to be executed by the one or more processors, the one or more programs comprise:
instructions for moving the robot to a first position of one of two edge lines of a preset detection signal region, wherein the preset detection signal region includes a detection signal emission region of at least one signal emitter on a charging base, and the two edge lines of the preset detection signal region are substantially axisymmetric with respect to a central line of a dock section of the charging base;
instructions for moving the robot from the first position to a second position of the other edge line of the preset detection signal region, wherein a track of the movement is substantially parallel to a lateral extension direction of the dock section of the charging base;
instructions for moving the robot from the second position to a midpoint of a line connecting the first position and the second position; and
instructions for moving the robot from the midpoint to the dock section of the charging base.

9. The robot of claim 8, wherein the instructions for moving the robot to the first position of the edge line of the preset detection signal region comprise:
receiving a detection signal emitted by a signal emitter on the charging base, and determining a current detection signal region the robot being located basing on the detection signal;
determining a moving direction of the robot basing on a positional relationship between the current detection signal region and the preset detection signal region; and
moving the robot along the determined moving direction from the current detection signal region to the first position of the edge line of the preset detection signal region.

10. The robot of claim 9, wherein the instructions for moving the robot along the determined moving direction from the current detection signal region to the first position of the edge line of the preset detection signal region comprise:
determining whether the received detection signal meets a preset condition while moving the robot along the determined moving direction; and
stopping the movement and taking a current position of the robot as the first position of the edge line of the preset detection signal region, in response to the received detection signal meeting the preset condition.

11. The robot of claim 8, wherein the instructions for moving the robot from the first position to the second position of the other edge line of the preset detection signal region comprise:
rotating, at the first position, an advance direction of the robot to a direction substantially parallel to the lateral extension direction of the dock section;
moving the robot from the first position along the rotated advance direction;
determining whether the received detection signal belongs to the preset detection signal region while moving the robot along the rotated advance direction; and
stopping the movement and taking a position the robot being located as the second position of the other edge line of the preset detection signal region, in response to the received detection signal not belong to the preset detection signal region.

12. The robot of claim 11, wherein the instructions for moving the robot from the second position to the midpoint of the line connecting the first position and the second position comprise:
calculating a distance between the second position and the midpoint basing on a distance between the first position and the second position; and
moving the robot for the calculated distance along a direction opposite to the rotated advance direction.

13. The robot of claim 8, wherein at least three signal emitters are provided on the charging base; and
the signal emitters are infrared signal emitters, the detection signals are infrared signals.

14. The robot of claim 8, wherein the instructions for moving the robot from the midpoint to the dock section of the charging base comprise:
moving from the midpoint to the dock section of the charging base, and detecting a movement trajectory of the robot to move to the charging base during the movement;
adjusting the moving direction of the robot until the robot docks at the charging base in response to the direction of the movement trajectory deviating from a direction heading the dock section of the charging base; and
rotating the robot such that a charging electrode of the robot aligns with the dock section.

15. An automatic recharging robotic system, comprising a charging base and a robot, wherein the charging base is provided with at least 3 signal emitters, and detection signals emitted by the at least 3 signal emitters are different to each other, the robot comprises a housing, a detection signal receiving device, and a motion control device, wherein:
the detection signal receiving device is disposed on the housing, the motion control device is disposed inside the housing, the detection signal receiving device and the motion control device are coupled to each other,
the detection signal receiving device is configured to receive a detection signal emitted by a signal emitter on a charging base and transmit the detection signal to the motion control device; and
the motion control device comprises one or more processors, a memory, and one or more computer programs, wherein the one or more programs are stored in the memory and configured to be executed by the one or more processors, the one or more programs comprise:
instructions for moving the robot to a first position of one of two edge lines of a preset detection signal region, wherein the preset detection signal region includes a detection signal emission region of at least one signal emitter on a charging base, and the two edge lines of the preset detection signal region are substantially axisymmetric with respect to a central line of a dock section of the charging base;
instructions for moving the robot from the first position to a second position of the other edge line of the preset detection signal region, wherein a track of the movement is substantially parallel to a lateral extension direction of the dock section of the charging base;
instructions for moving the robot from the second position to a midpoint of a line connecting the first position and the second position; and
instructions for moving the robot from the midpoint to the dock section of the charging base.

16. The system of claim 15, wherein the instructions for moving the robot to the first position of the edge line of the preset detection signal region comprise:
receiving a detection signal emitted by a signal emitter on the charging base, and determining a current detection signal region the robot being located basing on the detection signal;
determining a moving direction of the robot basing on a positional relationship between the current detection signal region and the preset detection signal region; and
moving the robot along the determined moving direction from the current detection signal region to the first position of the edge line of the preset detection signal region.

17. The system of claim 16, wherein the instructions for moving the robot along the determined moving direction from the current detection signal region to the first position of the edge line of the preset detection signal region comprise:
determining whether the received detection signal meets a preset condition while moving the robot along the determined moving direction; and
stopping the movement and taking a current position of the robot as the first position of the edge line of the preset detection signal region, in response to the received detection signal meeting the preset condition.

18. The system of claim 15, wherein the instructions for moving the robot from the first position to the second position of the other edge line of the preset detection signal region comprise:
rotating, at the first position, an advance direction of the robot to a direction substantially parallel to the lateral extension direction of the dock section;
moving the robot from the first position along the rotated advance direction;
determining whether the received detection signal belongs to the preset detection signal region while moving the robot along the rotated advance direction; and
stopping the movement and taking a position the robot being located as the second position of the other edge line of the preset detection signal region, in response to the received detection signal not belong to the preset detection signal region.

19. The system of claim 18, wherein the instructions for moving the robot from the second position to the midpoint of the line connecting the first position and the second position comprise:
calculating a distance between the second position and the midpoint basing on a distance between the first position and the second position; and
moving the robot for the calculated distance along a direction opposite to the rotated advance direction.

20. The system of claim 15, wherein at least 3 signal emitters are provided on the charging base; and
the signal emitters are infrared signal emitters, the detection signals are infrared signals.
